(19) United States
(12) Patent Application Publication
(10) Pub. No.: US 2025/0337603 A1
(43) Pub. Date: Oct. 30, 2025

(54) BLOCKCHAIN STATE DATABASE PERFORMANCE ENHANCEMENT SYSTEM USING STATE TRIE NODE AND MINING METHOD THEREOF

(71) Applicant: SEOUL NATIONAL UNIVERSITY R&DB FOUNDATION, Seoul (KR)

(72) Inventors: Soo Mook MOON, Seoul (KR); Jae Yun KIM, Seoul (KR); Jun Mo LEE, Seoul (KR)

(21) Appl. No.: 19/264,060

(22) Filed: Jul. 9, 2025

Related U.S. Application Data
(63) Continuation of application No. PCT/KR2024/002571, filed on Feb. 28, 2024.

(30) Foreign Application Priority Data
Feb. 28, 2023 (KR) 10-2023-0026897

(51) Int. Cl. H04L 9/00; G06Q 20/38; G06Q 20/40; H04L 9/32

(52) U.S. Cl. CPC H04L 9/50; G06Q 20/3827; G06Q 20/401; H04L 9/3236

(57) ABSTRACT

A mining method performed by node devices connected to a blockchain network, comprises: a step in which a specific node device acquires a transaction including a first block having a first block number and a first trie node related to specific state data of the blockchain network, and state change data for changing the state of a specific account; a step in which the specific node device generates a second block including a second trie node and a second block number, the second trie node being generated based on the transaction and the first trie node; and a step in which, if the hash value of a second node corresponding to a state path-being a path from a specific leaf node corresponding to the specific account to a specific root node-among one or more second nodes included in the second trie node satisfies a predetermined criterion.

### CROSS-REFERENCE TO RELATED APPLICATION

This application is a continuation of PCT Patent Application No. PCT/KR2024/002571 filed on Feb. 28, 2024, which claims priority to Korean Patent Application No. 10-2023-0026897, filed on Feb. 28, 2023, in the Korean Intellectual Property Office, the disclosure of which is incorporated by reference herein in its entirety.

### BACKGROUND

### Technical Field

The present invention relates to a blockchain state database performance enhancement system using a state trie node and a mining method thereof, and more specifically, to a system and method in which a second block is generated based on a first block and a new transaction, and when the hash value of a second node-among one or more second nodes included in a second trie node of the second block that has been changed from the first block-satisfies a predetermined condition such that the prefix of the hash value is identical to the block number of the second block, the changed second node from the first block is stored in the blockchain state database.

Blockchain is a technology that collects data into blocks and connects them in a chain using a peer-to-peer (P2P) method. More specifically, blockchain is a technology in which servers are operated by users and data is distributed and stored to prevent attackers from arbitrarily modifying the data. In addition, blockchain ensures data integrity and reliability by using hash functions and digital signatures. Currently, blockchain is widely utilized in various applications such as smart contracts, cryptocurrencies, and personal information authentication.

Account-based blockchains such as Ethereum store state data, which includes account data, in a blockchain state database using a data structure called a Merkle Patricia Trie. The trie node, which is the trie data structure of an account-based blockchain, includes a leaf node that stores an account, and intermediate and root nodes that contain path data distinguishing the route to the account address.

When a transaction is executed on a specific block in an account-based blockchain, a new block is generated in which the nodes of the trie node corresponding to the account affected by the transaction are changed. More specifically, the new block includes a trie node in which the leaf node for the account affected by the transaction in the specific block is changed, and the intermediate node and root node corresponding to the path of the changed account are newly generated. The trie node of the new block generates hash values for each node in the order of the newly created leaf node, intermediate node, and root node. The hash values of each node included in the trie node serve as pointers for the trie node. The newly created nodes in the new block are stored in the blockchain state database using the respective hash values of the nodes as keys. Since the unchanged nodes in the new block are already stored in the state database, the account status can be tracked by accessing the trie node of the previous block, i.e., the specific block.

In a blockchain structure of this type, the blockchain state database that stores state data occupies a very large portion of the entire blockchain data. Therefore, in order to execute transactions or perform verification for a specific block, it is necessary to access the state database using a hash value, which serves as a random key, when reading a trie node or storing a new trie node in the blockchain state database. As a result, significant performance degradation occurs in devices that execute transactions and verification.

### SUMMARY

Here is the formal patent-style English translation for the provided sections: The present invention is directed to resolving the aforementioned problem. Specifically, it provides a blockchain state database performance enhancement system and a mining method using a state trie node, wherein a second block is generated based on a first block and a transaction. If, among one or more second nodes included in a second trie node of the second block, the hash value of a second node modified from the first block satisfies a predetermined condition such that the prefix of the hash value matches the block number of the second block, then the modified second node from the first block is stored in the blockchain state database.

The technical problems to be achieved by the present invention are not limited to those described above, and other technical problems may be derived from the following description of the invention.

As a technical means for solving the aforementioned problems, one aspect of the present invention provides a blockchain state database performance enhancement mining method using a state trie node. This method is a mining method performed by node devices connected to a blockchain network, and includes: acquiring, by a specific node device, a first block including a first block number and a first trie node related to specific state data of the blockchain network, and a transaction including state change data for changing the state of a specific account; generating, by the specific node device, a second block including a second block number and a second trie node based on the transaction and the first trie node; and storing, by the specific node device, in the blockchain state trie and database a second node corresponding to a state path from a specific leaf node corresponding to the specific account to a specific root node, among one or more second nodes included in the second trie node, if the hash value of the second node satisfies a predetermined condition such that the prefix of the hash value is identical to the second block number.

In addition, as a technical means for solving the aforementioned problems, another aspect of the present invention provides a blockchain state database performance enhancement system using a state trie. This system includes: at least one processor; and a memory electrically connected to the processor and storing at least one code executed by the processor. The memory stores code which, when executed by the processor, causes the processor to: acquire a first block including a first block number and a first trie node related to specific state data of the blockchain network, and a transaction including state change data for changing the state of a specific account; generate a second block including a second trie node and a second block number based on the transaction and the first trie node; and store, in the blockchain state trie and database, a second node corresponding to a state path from a specific leaf node corresponding to the specific account to a specific root node, among one or more second nodes included in the second trie node, if the hash value of the second node satisfies a predetermined condition such that the prefix of the hash value is identical to the second block number.

According to the problem-solving means of the present invention described above, by ensuring that the prefix of the hash value for each of the modified nodes from the previous block among the one or more nodes included in the trie node of the newly generated block is identical to the block number of the newly generated block, the synchronization speed of transactions can be improved.

### BRIEF DESCRIPTION OF THE DRAWINGS

FIG. 1 is a diagram illustrating a system for improving blockchain state database performance using a state trie node and node devices connected to a blockchain network, according to an embodiment of the present invention.

FIG. 2 is a block diagram illustrating a configuration of the system for improving blockchain state database performance using a state trie node, as shown in FIG. 1.

FIG. 3 is a diagram illustrating an example of performing a proof-of-work consensus algorithm using the system for improving blockchain state database performance using a state trie node, as shown in FIG. 1.

FIG. 4 is a diagram illustrating an example of a blockchain state database.

FIG. 5A to 5C is a diagram illustrating an example in which a new trie node of a block generated by performing a proof-of-work algorithm is stored in a blockchain state database using a conventional blockchain mining system.

FIG. 6A to 6C is a diagram illustrating an example in which newly generated nodes of multiple blocks generated by a trie node proof-of-work consensus algorithm are stored in a blockchain state database.

FIG. 7 is a flowchart illustrating a method for improving blockchain state database performance using a state trie node, according to another embodiment of the present invention.

FIGS. 8 to 11 are flowcharts illustrating detailed steps included in the method for improving blockchain state database performance using a state trie node, as shown in FIG. 7.

### DETAILED DESCRIPTION

Hereinafter, the present invention will be described in detail with reference to the accompanying drawings. However, the present invention may be embodied in various different forms and is not limited to the embodiments described herein. Furthermore, the drawings are provided to facilitate understanding of the embodiments disclosed in the specification and are not intended to limit the technical spirit disclosed herein. All terms used herein, including technical and scientific terms, are to be interpreted according to their ordinary meanings as understood by those of ordinary skill in the art to which the present invention pertains. Unless otherwise defined, terms should not be interpreted in an excessively idealized or restrictive manner inconsistent with the technical context of the present invention.

For clarity of explanation, elements unrelated to the description of the invention are omitted from the drawings, and the size, shape, and configuration of components depicted in the drawings may be modified in various ways. Throughout the specification, like reference numerals denote the same or similar components.

The suffixes “module” and “unit” attached to the names of components in the following description are used merely for convenience in drafting the specification and are not intended to denote distinct meanings or roles. In addition, detailed descriptions of known techniques that may unnecessarily obscure the essence of the disclosed embodiments are omitted.

In the present specification, when a certain part is described as being “connected” (attached, contacted, or coupled) to another part, this includes both cases where they are “directly connected” (attached, contacted, or coupled), and cases where they are “indirectly connected” (attached, contacted, or coupled) with another element interposed therebetween. Furthermore, when a certain part is described as “including” (having or being provided with) another component, this does not exclude the presence of additional components unless explicitly stated otherwise, and it means that additional components may also be “included” (had or provided).

The ordinal terms such as “first,” “second,” and the like used in the present specification are intended merely to distinguish one element from another and do not limit the order or relationship of the components. For example, a first component of the invention may be referred to as a second component, and similarly, a second component may be referred to as a first component. Singular expressions used in the specification are to be interpreted as including plural expressions unless explicitly stated otherwise or unless the context clearly dictates otherwise.

The communication module described hereinafter may include a device comprising hardware and software necessary for transmitting and receiving signals such as control signals or data signals via wired or wireless communication with another network device. The memory may store at least one of the information and data input via the communication module, information and data required to perform functions by the processor, and data generated according to execution by the processor. The memory is to be interpreted as collectively referring to non-volatile storage devices that retain stored information even when power is not supplied, and volatile storage devices that require power to retain stored information. In addition to volatile storage devices that require power to retain stored information, the memory may include magnetic storage media or flash storage media, although the scope of the present invention is not limited thereto. The processor may include various types of devices for controlling and processing data. The processor may refer to a data processing device embedded in hardware having a physically structured circuit for performing functions expressed by code or instructions included in a program. For example, the processor may be implemented in forms such as a microprocessor, a central processing unit (CPU), a processor core, a multiprocessor, an application-specific integrated circuit (ASIC), or a field-programmable gate array (FPGA), but is not limited thereto.

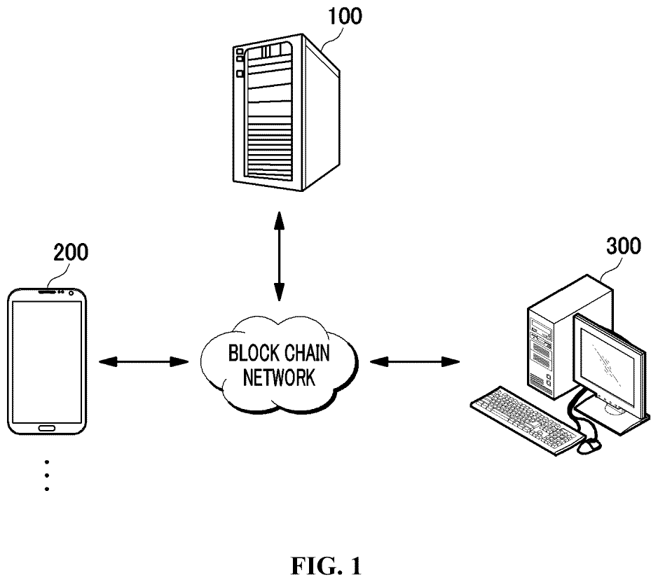

FIG. 1 is a diagram illustrating a blockchain state database performance enhancement system using a state trie node (hereinafter referred to as “blockchain system (100)”) according to an embodiment of the present invention and node devices (200, 300) communicatively connected to a blockchain network.

Referring to FIG. 1, the blockchain system (100) is interconnected with a blockchain network via a wired or wireless communication network and may be connected to node devices (200, 300) through the blockchain network. When a transaction is received by the blockchain network, the blockchain system (100) and node devices (200, 300) connected to the blockchain network may generate a new block to process the transaction. For example, each of the blockchain system (100) and the node devices (200, 300) may function as a node forming the blockchain network, and may be a system or device for processing transactions and generating new blocks to construct the blockchain. That is, the blockchain system (100) and node devices (200, 300) connected to the blockchain network may generate a new block associated with the received transaction. Here, the new block may be generated to include information regarding previously processed transactions, newly received transactions, and the like. For example, the new block may refer to a current block configured to be connected to a previous block containing information about previously processed transactions. The blockchain system (100) may be implemented as a cloud computing server such as Software as a Service (SaaS), Platform as a Service (PaaS), or Infrastructure as a Service (IaaS). The blockchain system (100) may also be another node device. The configuration, functions, and operations of the blockchain system (100) described below may also be performed in the same manner by the node devices (200, 300). The node devices (200, 300) may include all types of handheld-based wireless communication devices such as laptops, desktops, notebooks equipped with web browsers, wireless communication devices with portability and mobility, smartphones, and tablet PCs with touchpads. The communication network may be implemented as a wired network such as a Local Area Network (LAN), a Wide Area Network (WAN), or a Value Added Network (VAN), or as any type of wireless network such as a mobile radio communication network or a satellite communication network.

The node devices (200, 300) may be a client node device (200) and a mining node device (300).

The client node device (200) includes a communication module, a memory, an input/output module, and a processor. The communication module of the client node device (200) may transmit and receive information with the blockchain network. The memory of the client node device (200) stores a blockchain program. The name of the blockchain program is designated for convenience of explanation and does not limit the function of the program itself. The memory of the client node device (200) may be configured to store at least one of data input through the communication module of the client node device (200), data necessary for performing functions by the processor of the client node device (200), and data generated according to the execution of the processor of the client node device (200). The input/output module of the client node device (200) may receive information or data transmitted from the outside to the client node device (200), or output information or data held by the client node device (200) to the outside. For example, the input/output module of the client node device (200) may include a display, touchpad, speaker, and microphone.

The processor of the client node device (200) is configured to execute the blockchain program stored in the memory and perform the following functions and procedures.

The processor of the client node device (200) may generate a transaction and transmit the generated transaction to the blockchain network. The processor of the client node device (200) may transmit a proof request for a block generated by the transaction to the blockchain network.

The mining node device (300) includes a communication module, a memory, an input/output module, and a processor. The communication module of the mining node device (300) may transmit and receive information with the blockchain network. The memory of the mining node device (300) stores a blockchain mining program. The name of the blockchain mining program is designated for convenience of explanation and does not limit the function of the program itself. The memory of the mining node device (300) may be configured to store at least one of data input through the communication module of the mining node device (300), data necessary for performing functions by the processor of the mining node device (300), and data generated according to the execution of the processor of the mining node device (300). The input/output module of the mining node device (300) may receive information or data transmitted from the outside to the mining node device (300), or output information or data held by the mining node device (300) to the outside. For example, the input/output module of the mining node device (300) may include a display, touchpad, speaker, and microphone.

The processor of the mining node device (300) is configured to execute the blockchain program stored in the memory and perform the following functions and procedures.

The processor of the mining node device (300) receives information about a new block generated by a transaction. The new block includes state data and a block, and the state data is stored as a trie node including one or more nodes. The processor of the mining node device (300) derives a nonce value so that the hash value of each of one or more nodes in the newly generated trie node, which differs from the trie node of the previous block, satisfies a preset condition. The processor of the mining node device (300) transmits the nonce value for the newly generated block to the blockchain network and receives a reward.

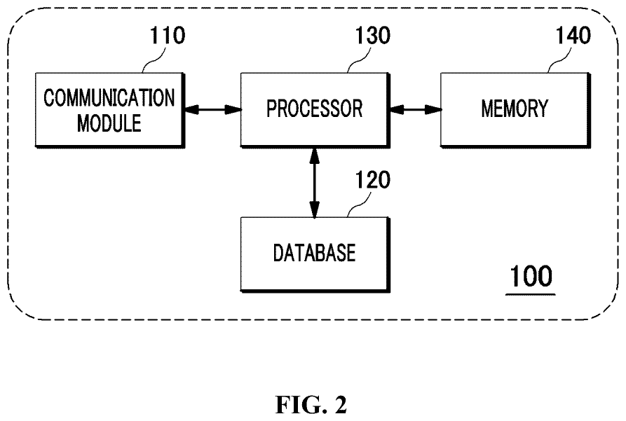

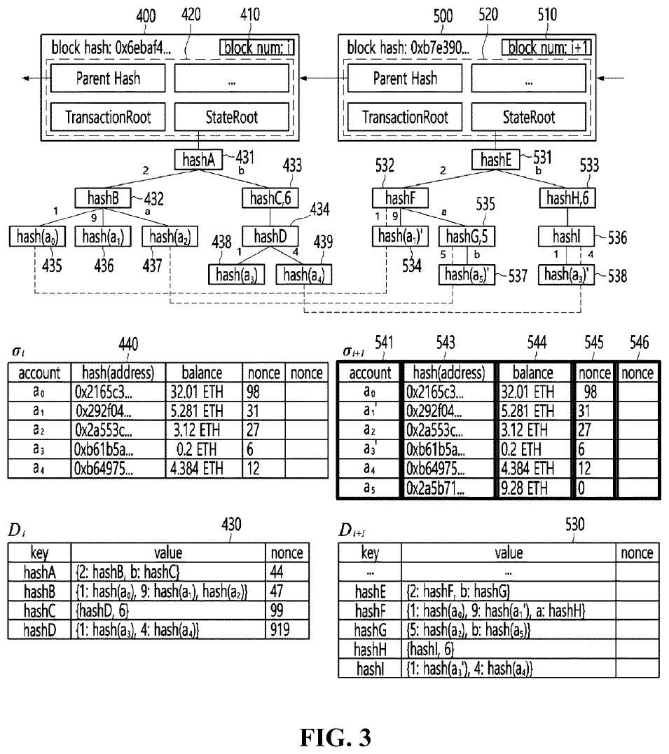

FIG. 2 is a block diagram illustrating the configuration of the blockchain system (100), and FIG. 3 is a diagram illustrating an example of performing a proof-of-work consensus algorithm through the blockchain state database performance enhancement system (100) using a state trie node.

Referring to FIGS. 2 and 3 together, the blockchain system (100) includes at least one processor (130) and a memory (140), and may further include a communication module (110) and a database (120).

The communication module (110) may transmit and receive information to and from external devices or servers, thereby transmitting and receiving data necessary to manage the blockchain based on the proof-of-work consensus algorithm for trie nodes.

The database (120) may be a place where data necessary for managing the blockchain based on the trie node proof-of-work consensus algorithm is stored. The database (120) may be built in a partial region of the memory (140) or implemented as separate hardware.

The processor (130) performs operations according to the code stored in the memory (140).

The memory (140) is electrically connected to the processor (130), and stores at least one code executed by the processor (130). The memory (140) stores code that, when executed by the processor (130), causes the processor (130) to perform the following functions and procedures.

The memory (140) stores code that causes the processor to acquire a first block (400) including a first block number (410) and a first trie node (430) related to specific state data of a blockchain network, and a transaction. The transaction may correspond to data and information for changing or updating the state of a trie node included in a tree structure. The tree structure may be a Merkle Patricia Trie data structure. The transaction includes state change data. The state change data is data for changing the state of a specific account. The state change data includes the address of the specific account and the number of transactions. The transaction may be obtained from a blockchain mempool. The relevant transaction is a new transaction not included in the first block.

The memory (140) stores code that causes the generation of a second block (500) including a second trie node (530) and a second block number (510), based on the transaction and the first trie node (430). The memory (140) generates the second block (500) by executing the transaction, and stores a transaction list including the second trie node (530) and one or more executed transactions in the second block (500). The memory (140) may generate the second trie node (530) created by changes resulting from the transaction, based on the first trie node (430) of the first block. More specifically, the memory (140) stores code that causes searching of first nodes corresponding to a state path, which is the path from a specific leaf node corresponding to a specific account to be changed via state change data of the transaction, to a specific root node, among first nodes included in the first trie node (430) of the first block (400). The first nodes corresponding to the state path included in the first trie node (430) may be a plurality of first nodes. The memory (140) stores code that causes generation of second nodes corresponding to the state path, based on the state change data and the state path, using the corresponding first nodes of the state path. More specifically, the memory (140) stores code that causes generation of account information of the leaf node corresponding to the specific account to be changed, based on the state change data, from the first node corresponding to the state path. If the leaf node corresponding to the specific account to be changed via the state change data is not present in the first node corresponding to the state path, the memory (140) stores code that causes generation of a leaf node for the specific account along the state path, based on the state change data. The memory (140) stores code that causes searching of sibling nodes of the second nodes corresponding to the state path. The sibling nodes of the second node corresponding to the state path are nodes having the same parent node as the second node corresponding to the state path. More specifically, the memory (140) stores code that causes searching of modified sibling nodes among the sibling nodes of the second node corresponding to the state path. For example, the sibling node of the leaf node (537) is the leaf node (437), and the sibling nodes of the intermediate node (535) are the leaf node (435) and the leaf node (534). The memory (140) stores code that causes generation of the second trie node (530) by associating the found sibling nodes with the second node corresponding to the state path.

For example, if the state path comprises the path data for the leaf node (436) including hash (a1) and the leaf node (438) including hash (a3), the path data of the leaf node (436) is ‘/ 2/9’ and the path data of the leaf node (438) is ‘/b/6/1’. Therefore, the first nodes include the root node (431) containing hash A, the intermediate node (432) containing hash B, the leaf node (436), the intermediate node (433) containing hash C, the intermediate node (434) containing hash D, and the leaf node (438). Among the second nodes, the leaf nodes (534, 538) are generated based on the first nodes by the state change data of the transaction. If the state change data of the transaction is data related to the account of a specific leaf node (537), and the state path is ‘2/a/5/b’, which corresponds to the path data of the specific leaf node (537), and the first nodes do not include a leaf node corresponding to the specific leaf node (537), then the second trie node in which the specific leaf node (537) is newly generated can be formed based on the first nodes.

The first nodes (431 to 439) included in the first block (400) and the second nodes (435, 437, 439, 531 to 538) included in the second block comprise at least one of root nodes (431, 531), intermediate nodes (432, 433, 434, 532, 533, 535, 536), and leaf nodes (435, 436, 437, 438, 439, 537, 538). A root node is associated with intermediate nodes or leaf nodes as child nodes. For example, the child nodes of root node (431) having hash value hash A are intermediate node (432) with hash value hash B and intermediate node (433) with hash value hash C. An intermediate node is associated with other intermediate nodes or with leaf nodes as child nodes. For example, the child nodes of intermediate node (532) with hash value hash F include leaf node (435) with hash value hash (a0), leaf node (534) with hash value hash (a1), and intermediate node (535) with hash value hash G. The root node and intermediate node each include path data for the child node, a nonce field where a nonce value is input, and a hash value. For example, root node (431) with hash value Hash A includes path data like {2: hash B, b: hash C} and a nonce field. A leaf node includes account information, such as account (541), address (543), balance (544), and transaction count (545), along with a nonce field (546) where a nonce value is input, and a hash value. The hash value of a leaf node is stored in a codeHash field if the account is a smart contract. If the account is a smart contract, the leaf node further includes a field (storageRoot) for storing the storage trie. The hash value of an intermediate node is calculated based on the hash values of one or more child nodes associated with it according to the path data of the intermediate node and the nonce value input in the nonce field of the intermediate node. The hash value of a root node is calculated based on the hash values of one or more child nodes associated with it according to the path data of the root node and the nonce value input in the nonce field of the root node. The hash value of a leaf node is calculated based on the account information of the leaf node and the nonce value input in the nonce field of the leaf node.

The memory (140) stores code that causes the system to store, in the blockchain state trie and database, a second node corresponding to a state path among one or more second nodes included in the second trie node (530), if the hash value of the second node corresponding to the state path satisfies a predetermined condition. The second block number (510) of the second block (500) has a greater value than the first block number (410) of the first block (400). The predetermined condition is that the prefix of the hash value of the second node corresponding to the state path is the same as the second block number (510) of the second block (500). The predetermined condition may further include a condition that the hash value of the second node corresponding to the state path is less than a hash value that satisfies a predefined difficulty. The hash value of the second node corresponding to the state path may be derived by generating a nonce value for the second node corresponding to the state path and using the generated nonce value along with the second node corresponding to the state path. More specifically, the memory (140) stores code that causes the system to generate a nonce value for the second node corresponding to the state path, insert the nonce value into the nonce field of the second node corresponding to the state path, and derive a hash value. The blockchain state database may be partially implemented within the database (120).

More specifically, the memory (140) stores code that causes the system to derive the hash value of the second node corresponding to the state path and determine whether the derived hash value satisfies the predetermined condition. The memory (140) stores code that causes the system to generate a nonce value for a first leaf node included in the second node corresponding to the state path, and determine whether the hash value of the first leaf node, derived based on the nonce value and the account information of the first leaf node, satisfies the predetermined condition. The first leaf node may be one of a plurality of leaf nodes (534, 537, 538), and the hash value of the first leaf node refers to the hash value of each of the plurality of leaf nodes (534, 537, 538). If the hash value of the first leaf node satisfies the predetermined condition, the memory (140) stores code that causes the system to generate a nonce value for a first parent node associated with the first leaf node, and determine whether the hash value of the first parent node, derived based on the nonce value and the hash values of one or more child nodes associated with the first parent node, satisfies the predetermined condition. If the hash value of the first parent node satisfies the predetermined condition and a second parent node associated with the first parent node exists, the memory (140) stores code that causes the system to generate a nonce value for the second parent node, and determine whether the hash value of the second parent node, derived based on the nonce value and the hash values of one or more child nodes associated with the second parent node, satisfies the predetermined condition. The first parent node and the second parent node may be intermediate nodes included in the second node or a root node included in the second nodes. If the first parent node or the second parent node is the root node included in the second nodes, the memory (140) stores code that causes the system to derive a hash value for the state root included in the block header of the second block (500), based on the hash value of the root node included in the second nodes, when the hash value satisfies the predetermined condition.

The memory (140) stores code that causes the system to store data in the blockchain state database by setting the hash value of the second node, which satisfies the predetermined condition, as the key for the second node. If the second node is a root node or an intermediate node, the path data for the child node of the second node is set as the value corresponding to the key. If the second node is a leaf node, the account information included in the second node is set as the value corresponding to the key.

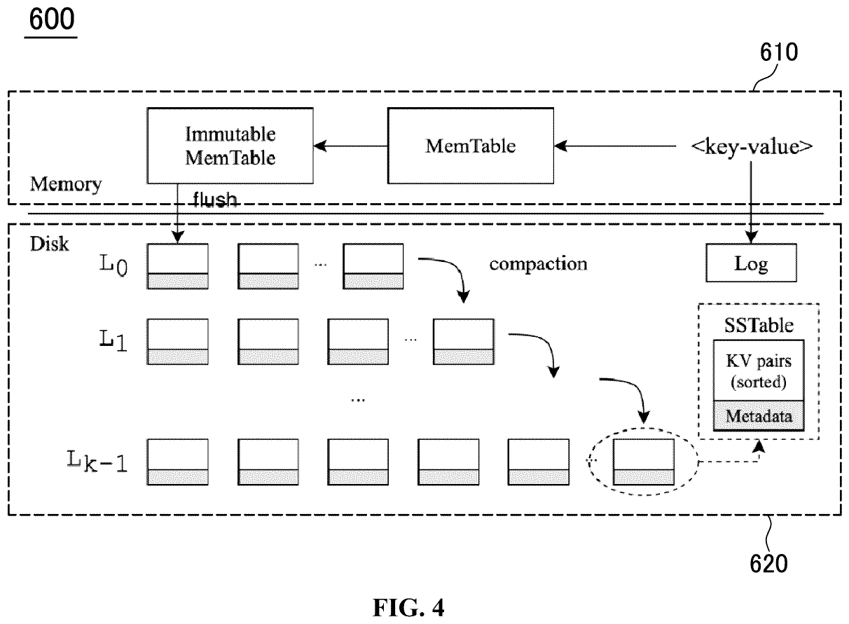

FIG. 4 illustrates an example of a blockchain state database.

Referring to FIG. 4, the blockchain state database (600) includes a memory area (610) and a disk area (620). The blockchain state database may be implemented using LevelDB.

The memory area (610) may divide the entire spatial area into a plurality of cell regions with fixed sizes and store spatial data objects in the memory area (610) defined in memory. Here, the entire spatial area refers to a spatial region that can contain spatial data and is the target of spatial queries. The memory area (610) may be a specific region of memory where index information about the spatial data objects is stored. The memory area (610) can divide the entire spatial area into 2″ cell regions of fixed size and store the spatial data objects distributed across each cell region. The memory area (610) may be implemented as a MemTable. When a second block (500), which includes a second trie node (530) comprising a second node updated from the first trie node (430) of the first block (400) by a transaction, is generated, the second node of the second block (500) is stored in the memory area (610). More specifically, the hash values of the second nodes are stored as keys in the memory area (610), and the path data for child nodes included in the second node or the account information is stored as the value corresponding to each key.

The disk area (620) includes a multi-level index area (L0 to Lk−1). When the amount of data stored in the memory area (610) exceeds the available capacity of memory, the data stored in the memory area (610) is flushed to the multi-level index area (L0 to Lk−1). The flushed data is converted into a string table and stored as such. The string table may be an SSTable. In the string table, key-value pairs of nodes are stored. If the number of string tables in a specific index level (Li) is a multiple of the number in the previous level (Li−1), the multiple may be, for example, ten times. When the number of string tables in the first index level (L0) reaches a threshold, the string tables are compacted and stored in the second index level (L1). The compaction process involves merging and sorting the string tables in L0 and L1 and splitting them into new string tables to be stored in L1. If the number of string tables in the second index level (L1) reaches a threshold, they are compacted and stored in the third index level (L2). This process is repeated through to the final index level (Lk−1). Since the compaction process of the multi-level index area involves sorting during memory load/store operations, it incurs the most overhead in the blockchain state database (600). However, in the present invention, the hash values of the newly created nodes included in the trie node of the newly generated block become the new block number as part of the trie node proof-of-work consensus algorithm, which reduces the overhead from sorting during compaction. Although the blockchain state database (600) may accelerate write performance through the memory area (610), the compaction process in the disk area (620) may degrade write performance. The read process in the multi-level index area (L0 to Lk−1) of the disk area (620) involves searching from the first index level (L0) to the last index level (Lk−1) in order to find the key.

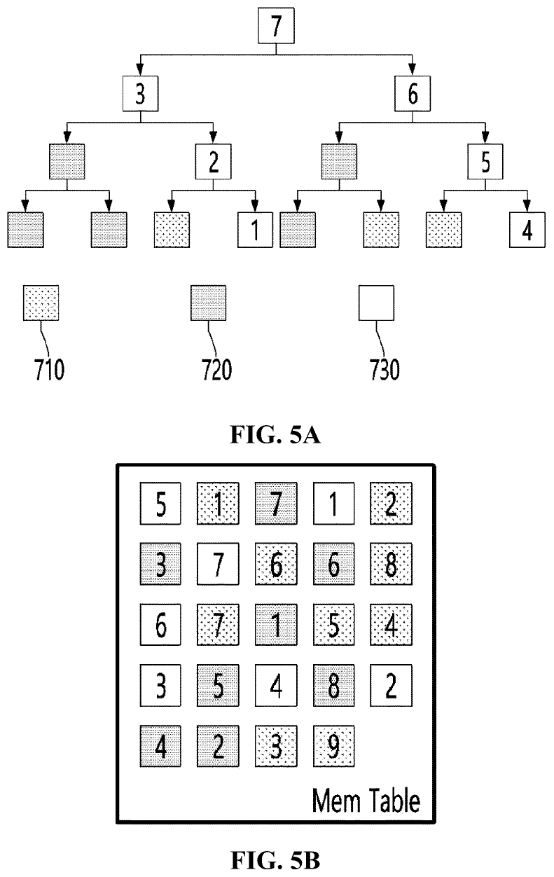

FIG. 5A to 5C illustrates an example in which a newly generated trie node of a single block created by performing a proof-of-work algorithm in the blockchain state database (600) through a conventional blockchain mining system is stored. FIG. 5A shows an example of a trie node filled with newly generated nodes from a plurality of blocks. FIG. 5B shows an example in which the nodes generated by performing the proof-of-work consensus algorithm through the conventional blockchain mining system are stored in the memory area (610). FIG. 5C shows a process of sorting the nodes stored in the memory area (610) in accordance with the data structure.

Referring to FIGS. 5A to 5C, blocks a0, a1, and a2 generated through the proof-of-work consensus algorithm by the conventional blockchain mining system each include newly created nodes (710, 720, 730). The newly created nodes (710) of block a0, (720) of block a1, and (730) of block a2 have random hash values. When the hash values of the newly created nodes (710, 720, 730) are used as keys and stored in the memory area (610), they are stored randomly due to their random hash values. The newly created nodes (710, 720, 730) stored in the memory area are converted into string tables and stored in the first index level (L0) of the disk area (620). When the first index level (L0) becomes full, the string tables of the newly created nodes (710, 720, 730) are compacted and split into multiple string tables, which are then stored in the second index level (L1).

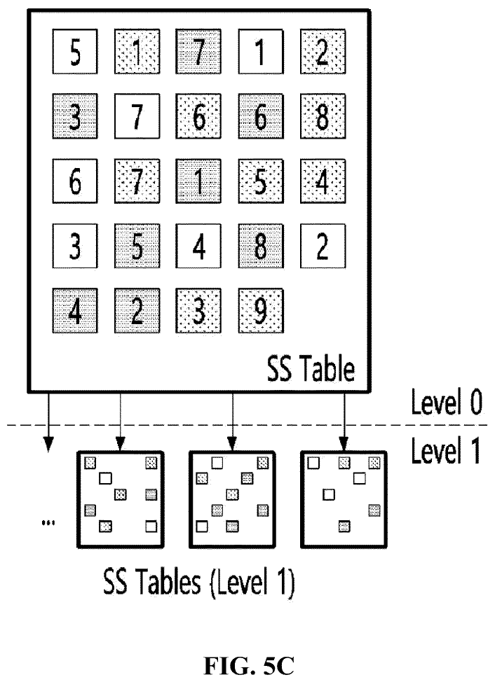

FIG. 6A to 6C illustrates an example in which newly generated nodes of multiple blocks created through a trie node proof-of-work consensus algorithm are stored in the blockchain state database (600). FIG. 6A shows an example of a trie node filled with newly generated nodes of multiple blocks. FIG. 6B shows an example in which the nodes generated through the trie node proof-of-work consensus algorithm are stored in the memory area (610). FIG. 6C illustrates a process of sorting the nodes stored in the memory area (610) according to the data structure. Referring to FIGS. 6A to 6C, blocks a0, a1, and a2 generated through the trie node proof—of-work consensus algorithm each include newly created nodes (810, 820, 830). The hash values of the newly created nodes (810) of block a0, (820) of block a1, and (830) of block a2 each have a prefix that matches the block number. When the hash values of the newly generated nodes (810, 820, 830) are used as keys and stored in the memory area (610), they are stored in a sequentially sorted manner according to the hash values. For example, the hash values of the newly created nodes (810) of block a0 have the prefix 0x0a0, the hash values of the newly created nodes (820) of block a1 have the prefix 0x0a1, and the hash values of the newly created nodes (830) of block a2 have the prefix 0x0a2. Thus, they are stored in the memory area (610) in ascending order of block creation. The newly created nodes (810, 820, 830) stored in the memory area are converted into string tables and stored in the first index level (L0) of the disk area (620). When the first index level (L0) becomes full, the string tables of the newly created nodes (810, 820, 830) are compacted and stored in the second index level (L1). Since the newly created nodes (810, 820, 830) stored in the memory area (610) are sorted by hash values, the sorting process during compaction in the disk area can be minimized. Accordingly, the compaction process is simplified, enabling faster synchronization of transactions to the blockchain state database (600) and improving the performance of data writing and reading. Because the newly created nodes (810, 820, 830) are sorted by hash values, the string tables in the first index level (L0) do not significantly overlap in range with other string tables, thus reducing the likelihood of false positives. A false positive refers to a case in which a key falls within the range of a string table but does not actually exist in that table. Moreover, since the ranges of the string tables in other index levels (L1 to Lk−1) are mostly separated, false positives rarely occur.

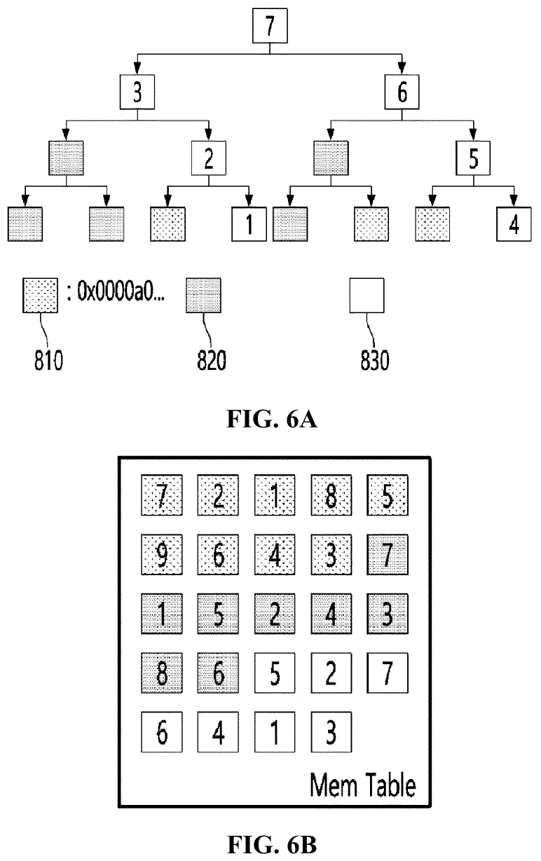

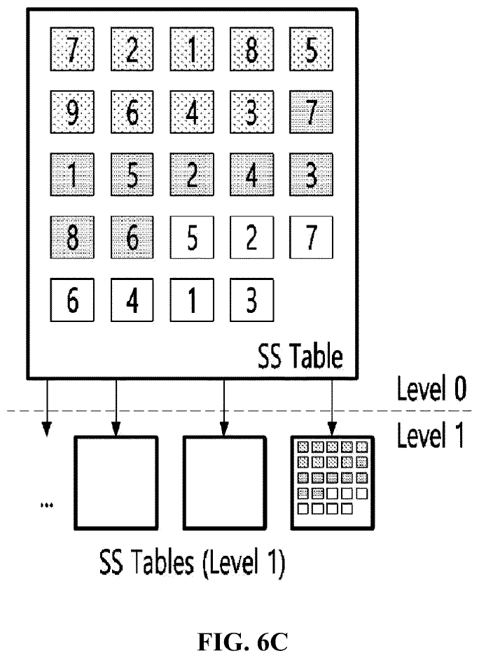

FIG. 7 is a flowchart illustrating a mining method for improving the performance of a blockchain state database using a state trie node according to another embodiment of the present invention. FIGS. 8 to 11 are flowcharts showing detailed steps included in the respective steps of the mining method for improving the performance of a blockchain state database using a state trie node. With reference to FIGS. 7 to 11, a description will now be given of the mining method for improving the performance of a blockchain state database using a state trie node. Each step of the mining method for improving the performance of a blockchain state database using a state trie node, described below, may be performed by the blockchain state database performance enhancement system (100) using state trie nodes as described with reference to FIGS. 1 to 6. Accordingly, the descriptions of the embodiments in FIGS. 1 to 6 may equally apply to the following embodiments, and overlapping descriptions will be omitted for clarity. The steps described below do not necessarily have to be performed in the given order, and the order may vary. Some steps may also be performed simultaneously.

Referring to FIG. 7, the mining method for improving the performance of a blockchain state database using a state trie node is a mining method performed by node devices connected to the blockchain network. The method includes a transaction acquisition step (S1100), a block generation step (S1200), and a hash value derivation and storage step (S1300).

In the transaction acquisition step (S1100), a specific node device acquires a first block including a first block number and a first trie node related to specific state data of the blockchain network, and a transaction including state change data for modifying the state of a specific account.

The block generation step (S1200) is a step in which a specific node device generates a second block that includes a second trie node generated based on the transaction and the first trie node, and a second block number.

The hash value derivation and storage step (S1300) is a step in which a specific node device stores a second node corresponding to the state path—the path from a specific leaf node corresponding to a specific account to be changed via the state change data to a specific root node—in the blockchain state trie and database, if the hash value of the second node satisfies a predetermined criterion such that the prefix of the hash value is identical to the second block number. The hash value of the second node corresponding to the state path is derived by the specific node device by generating a nonce value for the second node corresponding to the state path and computing the hash value based on the nonce value and the second node.

Referring to FIG. 8, the block generation step (S1200) includes a node search step (S1210), a node generation step (S1220), a sibling node search step (S1230), and a trie node generation step (S1240).

The block generation step (S1200), as shown in FIG. 8, includes a node search step (S1210), a node generation step (S1220), a sibling node search step (S1230), and a trie node generation step (S1240). The node search step (S1210) is a step in which a specific node device searches for a first node corresponding to a state path among the first nodes included in the first trie node. The node generation step (S1220) is a step in which a specific node device generates a second node corresponding to the state path based on the first node using the state change data and the state path. The sibling node search step (S1230) is a step in which the device searches for a sibling node of the second node. The trie node generation step (S1240) is a step in which the device associates the found sibling node with the second node to generate the second trie node. The searched sibling node in the second trie node is a node not corresponding to the transaction's state path.

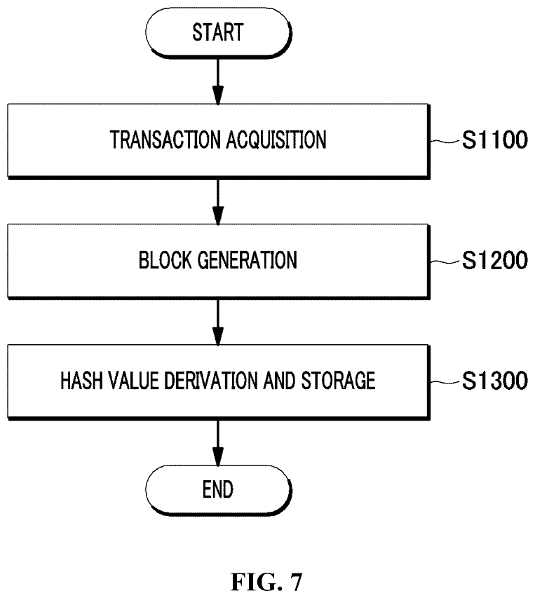

As shown in FIG. 9, the node generation step (S1220) includes a leaf node generation step (S1221) and a leaf node addition step (S1222).

The leaf node generation step (S1221) is a step in which a specific node device generates account information of the leaf node corresponding to a specific account from the first node based on the state change data. The leaf node addition step (S1222) is a step in which, if no leaf node corresponding to a specific account exists in the first node, the device generates a leaf node along the state path based on the state change data.

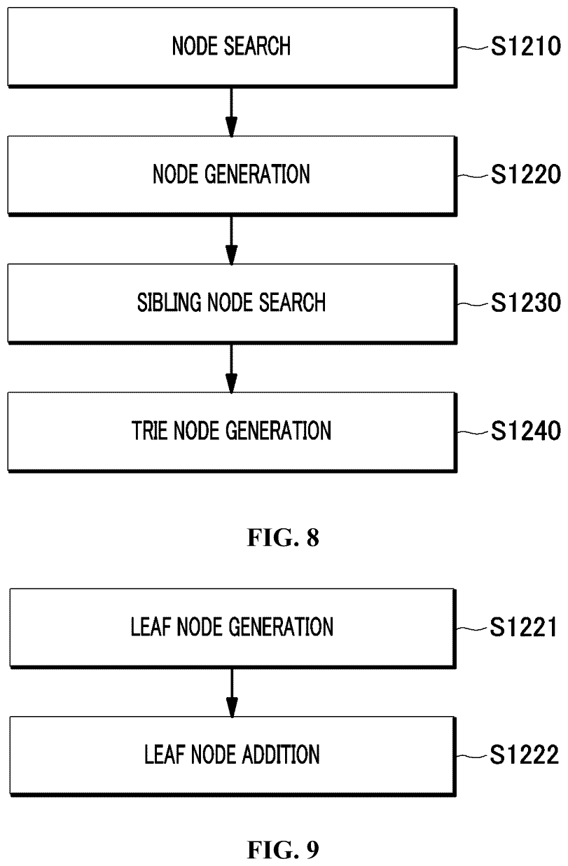

As shown in FIG. 10, the hash value derivation step (S1300) includes a step of deriving hash values for each node (S1310) and a step of storing node information (S1320).

The step of deriving hash values for each node (S1310) is a step in which a specific node device derives a hash value for the second node corresponding to the state path and determines whether the derived hash value satisfies a predetermined criterion.

The step of storing node information (S1320) is a step in which the specific node device sets the hash value satisfying the predetermined criterion as the key for the second node, and if the second node is a root or intermediate node, stores the path data for the child node as the value for the key. If the second node is a leaf node, the account information included in the second node is stored as the value for the key in the blockchain state database.

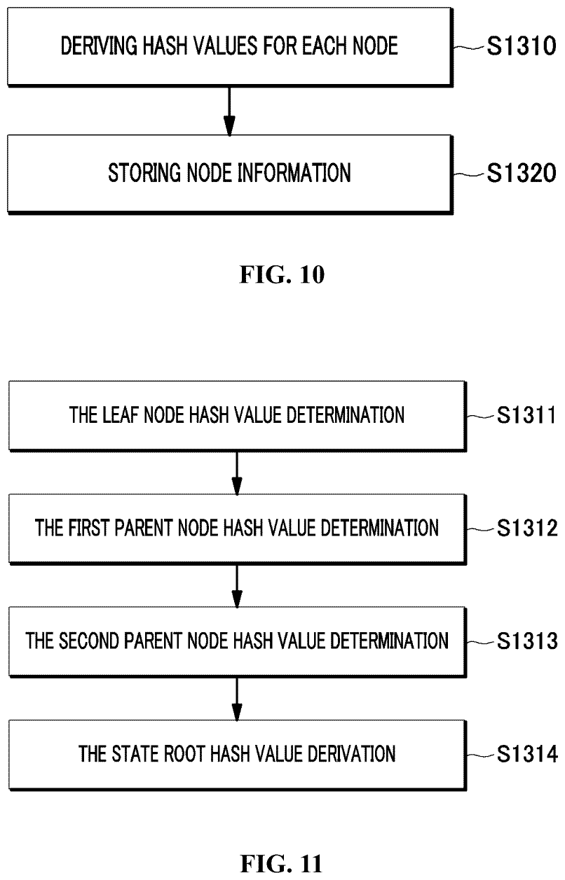

As shown in FIG. 11, the step of deriving hash values for each node (S1310) includes a leaf node hash value determination step (S1311), a first parent node hash value determination step (S1312), a second parent node hash value determination step (S1313), and a state root hash value derivation step (S1314).

The leaf node hash value determination step (S1311) is a step in which a specific node device generates a nonce value for a first leaf node included in the second node corresponding to the state path, and determines whether the hash value of the first leaf node-derived based on the nonce value and the account information of the first leaf node-satisfies a predetermined criterion.

The first parent node hash value determination step (S1312) is a step in which, if the hash value of the first leaf node satisfies the predetermined criterion, the specific node device generates a nonce value for a first parent node associated with the first leaf node and determines whether the hash value of the first parent node-derived based on the nonce value and the hash values of one or more child nodes associated with the first parent node-satisfies the predetermined criterion.

The second parent node hash value determination step (S1313) is a step in which, if the hash value of the first parent node satisfies the predetermined criterion and a second parent node associated with the first parent node exists, the specific node device generates a nonce value for the second parent node and determines whether the hash value of the second parent node-derived based on the nonce value and the hash values of one or more child nodes associated with the second parent node-satisfies the predetermined criterion.

The state root hash value derivation step (S1314) is performed when the first parent node and the second parent node are intermediate nodes or root nodes included in the second node, and when either the first parent node or the second parent node is the root node included in the second node. The state root hash value derivation step (S1314) is a step in which, if the hash value of the root node included in the second node satisfies a predetermined criterion, a hash value for the state root included in the block header of the second block is derived based on the hash value of the root node.

As described above, the mining method for improving the performance of a blockchain state database using state trie nodes according to the embodiments of the present invention may also be implemented in the form of a recording medium including computer-executable instructions, such as program modules executed by a computer. The computer-readable medium may be any available medium that can be accessed by a computer and includes both volatile and non-volatile media, as well as removable and non-removable media. Furthermore, the computer-readable medium may include computer storage media. The computer storage media include both volatile and non-volatile, removable and non-removable media implemented in any method or technology for storage of information such as computer-readable instructions, data structures, program modules, or other data.

Those of ordinary skill in the art to which the present invention pertains will understand that various modifications can be made in other specific forms without changing the technical spirit or essential characteristics of the present invention based on the foregoing description. Therefore, the embodiments described above are to be understood as illustrative and not limiting in all respects. The scope of the present invention is indicated by the claims described below, and all modifications or variations derived from the meanings and scope of the claims and their equivalents are to be construed as being included within the scope of the present invention. The scope of the present application is defined not by the above detailed description but by the claims described below, and all modifications or variations derived from the meanings and scope of the claims and their equivalents are to be construed as being included within the scope of the present application.

What is claimed is:

1. A mining method performed by node devices connected to a blockchain network, comprising:
a) acquiring, by a specific node device, a transaction including state change data for changing a state of a specific account and a first block including a first trie node related to specific state data of the blockchain network and a first block number;
b) generating, by the specific node device, a second block including a second trie node and a second block number, the second trie node being generated based on the transaction and the first trie node; and
c) storing, by the specific node device, a second node corresponding to a state path from a specific leaf node corresponding to the specific account to a specific root node, among one or more second nodes included in the second trie node, in a blockchain state trie and a database, if a hash value of the second node corresponding to the state path satisfies a preset condition such that a prefix of the hash value is identical to the second block number,
wherein the method is a mining method for improving performance of a blockchain state database using a state trie node.

2. The mining method for improving performance of a blockchain state database using a state trie node according to claim 1,
wherein the hash value is derived by the specific node device by generating a nonce value for the second node corresponding to the state path and based on the nonce value and the second node corresponding to the state path.

3. The mining method for improving performance of a blockchain state database using a state trie node according to claim 2,
wherein the first node included in the first block and the second node included in the second block comprise at least one of a root node, an intermediate node, and a leaf node;
the root node is associated with the intermediate node and a child node or with the leaf node and a child node;
the intermediate node is associated with another intermediate node and a child node or with the leaf node and a child node;
the root node and the intermediate node include path data for child nodes, a nonce field into which a nonce value is input, and a hash value;
the leaf node includes account information comprising an account, address, balance, and transaction count, a nonce field into which a nonce value is input, and a hash value;
the hash value of the intermediate node is calculated based on the hash values of one or more child nodes associated according to the path data of the intermediate node and the nonce value input into the nonce field of the intermediate node;
the hash value of the root node is calculated based on the hash values of one or more child nodes associated according to the path data of the root node and the nonce value input into the nonce field of the root node;
the hash value of the leaf node is calculated based on the account information and the nonce value input into the nonce field of the leaf node; and
the state change data includes the address and transaction count of the specific account.

4. The mining method for improving performance of a blockchain state database using a state trie node according to claim 3, comprising:
b-1) a step in which the specific node device searches for a first node, among the first nodes included in the first trie node, that corresponds to the state path;
b-2) a step in which the specific node device generates a second node corresponding to the state path based on the first node corresponding to the state path, using the state change data and the state path;
b-3) a step in which the specific node device searches for sibling nodes of the second node corresponding to the state path; and
b-4) a step in which the specific node device associates the searched sibling nodes with the second node corresponding to the state path to generate the second trie node.

5. The mining method for improving performance of a blockchain state database using a state trie node according to claim 4,
wherein step b-2) comprises:
a step in which the specific node device generates account information of a leaf node corresponding to the specific account at the first node corresponding to the state path based on the state change data; or
a step in which, when no leaf node corresponding to the specific account exists at the first node corresponding to the state path, the specific node device generates a leaf node for the specific account according to the state path based on the state change data.

6. The mining method for improving performance of a blockchain state database using a state trie node according to claim 3,
wherein step c) comprises:
c-1) a step in which the specific node device derives the hash value and determines whether the hash value satisfies a preset criterion; and
c-2) a step in which the specific node device sets the hash value satisfying the preset criterion as a key for the second node,
and when the second node is a root node or an intermediate node, sets path data for child nodes of the second node as a value for the key,
and when the second node is a leaf node, sets account information included in the second node as the value for the key,
and stores the key-value pair in the blockchain state database.

7. The mining method for improving performance of a blockchain state database using a state trie node according to claim 6,
wherein step c-1) comprises:
a step in which the specific node device generates a nonce value for a first leaf node included in the second node corresponding to the state path, and determines whether a hash value of the first leaf node, derived based on the nonce value and account information of the first leaf node, satisfies the preset criterion;
a step in which, if the hash value of the first leaf node satisfies the preset criterion, the specific node device generates a nonce value for a first parent node associated with the first leaf node, and determines whether a hash value of the first parent node, derived based on the nonce value and hash values of one or more child nodes associated with the first parent node, satisfies the preset criterion; and
a step in which, if the hash value of the first parent node satisfies the preset criterion and a second parent node associated with the first parent node exists, the specific node device generates a nonce value for the second parent node, and determines whether a hash value of the second parent node, derived based on the nonce value and hash values of one or more child nodes associated with the second parent node, satisfies the preset criterion.

8. The mining method for improving performance of a blockchain state database using a state trie node according to claim 7,
wherein the first parent node and the second parent node are either intermediate nodes or a root node included in the second node,
and if the first parent node or the second parent node is the root node included in the second node,
the method further comprises a step in which, if the hash value of the root node included in the second node satisfies the preset criterion,
a hash value for a state root included in a block header of the second block is derived based on the hash value of the root node included in the second node.

9. The mining method for improving performance of a blockchain state database using a state trie node according to claim 1,
wherein the second block number has a value greater than the first block number.

10. The method of claim 1,
wherein the predetermined condition further includes a condition that the hash value is smaller than a hash value satisfying a predetermined difficulty level,
in a blockchain state database performance improvement mining method using a state trie.

11. A system for improving the performance of a blockchain state database using a state trie, comprising:
at least one processor; and
a memory electrically connected to the processor and storing at least one code executable by the processor,
wherein the memory stores code which, when executed by the processor, causes the processor to:
obtain a transaction including a first block having a first block number and a first trie node related to specific state data of a blockchain network, and state change data for changing the state of a specific account;
generate a second block including a second trie node and a second block number based on the transaction and the first trie node; and
store, in the blockchain state trie and database, a second node corresponding to a state path, which is a path from a specific leaf node corresponding to the specific account to a specific root node among one or more second nodes included in the second trie node,
if a hash value of the second node satisfies a predetermined condition such that the prefix of the hash value is the same as the second block number.

12. The system for improving the performance of a blockchain state database using a state trie according to claim 11,
wherein the hash value is derived by generating a nonce value for the second node corresponding to the state path, and using the nonce value and the second node corresponding to the state path.

13. The system for improving the performance of a blockchain state database using a state trie according to claim 12,
wherein the first node included in the first block and the second node included in the second block comprise at least one of a root node, an intermediate node, and a leaf node,
the root node is associated with a child node as either an intermediate node or a leaf node,
the intermediate node is associated with a child node as either another intermediate node or a leaf node,
the root node and the intermediate node include path data for child nodes, a nonce field into which a nonce value is input, and a hash value,
the leaf node includes account information comprising an account, address, balance, and transaction count, as well as a nonce field into which a nonce value is input and a hash value, the hash value of the intermediate node is calculated based on the nonce value input into its nonce field and the hash values of one or more child nodes associated according to the path data of the intermediate node,
the hash value of the root node is calculated based on the nonce value input into its nonce field and the hash values of one or more child nodes associated according to the path data of the root node,
the hash value of the leaf node is calculated based on the account information and the nonce value input into its nonce field, and
the state change data includes an address and transaction count of a specific account.

14. The system for improving the performance of a blockchain state database using a state trie according to claim 13,
wherein the memory stores code that causes the processor to:
search, among first nodes included in the first trie node, a first node corresponding to the state path;
generate a second node corresponding to the state path based on the first node corresponding to the state path by using the state change data and the state path;
search for sibling nodes of the second node corresponding to the state path; and
generate the second trie node by associating the searched sibling nodes with the second node corresponding to the state path.

15. The system for improving the performance of a blockchain state database using a state trie according to claim 13,
wherein the memory stores code that causes the processor to:
derive a hash value, determine whether the hash value satisfies a predetermined criterion, and
when the hash value satisfies the predetermined criterion,
set the hash value as a key for the second node, and
store, in the blockchain state database, either:
path data of child nodes of the second node as a value corresponding to the key, if the second node is a root node or an intermediate node; or
account information included in the second node as a value corresponding to the key, if the second node is a leaf node.

16. The system for improving the performance of a blockchain state database using a state trie according to claim 15,
wherein the memory stores code that causes the processor to:
generate a nonce value for a first leaf node included in the second node corresponding to the state path;
determine whether a hash value derived from the nonce value and account information of the first leaf node satisfies the predetermined criterion;
if the hash value of the first leaf node satisfies the predetermined criterion, generate a nonce value for a first parent node associated with the first leaf node;
determine whether a hash value derived from the nonce value and the hash values of one or more child nodes associated with the first parent node satisfies the predetermined criterion; and
if the hash value of the first parent node satisfies the predetermined criterion and a second parent node associated with the first parent node exists,
generate a nonce value for the second parent node and determine whether a hash value derived from the nonce value and the hash values of one or more child nodes associated with the second parent node satisfies the predetermined criterion.

17. The system for improving the performance of a blockchain state database using a state trie according to claim 16,
wherein the first parent node and the second parent node are intermediate nodes or a root node included in the second node,
and if the first parent node or the second parent node is a root node included in the second node,
the memory stores code that causes the processor to derive a hash value for a state root included in a block header of the second block,
based on a hash value of the root node included in the second node,
when the hash value of the root node satisfies the predetermined criterion.

18. The system for improving the performance of a blockchain state database using a state trie according to claim 11,
wherein the second block number has a value greater than the first block number.

19. The system for improving the performance of a blockchain state database using a state trie according to claim 11,
wherein the predetermined criterion further includes a criterion that causes the hash value to be smaller than a hash value satisfying a predetermined difficulty.
